(19) United States
(12) Patent Application Publication
(10) Pub. No.: US 2024/0201690 A1
(43) Pub. Date: Jun. 20, 2024

(54) SYSTEMS AND METHODS FOR IDENTIFYING OBJECTS IN A SPACE

(71) Applicant: INDOOR ROBOTICS LTD., Ramat-Gan (IL)

(72) Inventors: NATAN SHEMER, GIVATAYIM (IL); RUBEN MERGUI, RAMAT-GAN (IL)

(21) Appl. No.: 18/080,883

(22) Filed: Dec. 14, 2022

(51) Int. Cl. G05D 1/02

(52) U.S. Cl. CPC G05D 1/0238; G05D 1/0246; G05D 1/0274

(57) ABSTRACT

A method for identifying objects by a mobile robot moving in a space by obtaining a map of the space, the map including objects and objects' locations in the space, moving the robot inside the space, localizing the moving robot in the space, capturing an image in the space using an image sensor of the mobile robot, identifying an object from the captured image, computing a relative direction of the object from the camera's direction at the time of capturing the image, and determining that the object that appears in the image is the same object that appears on the map based on the relative direction, the robot's location when capturing the image, and the object's location on the map.

### FIELD

The invention, in embodiments thereof, relates to identifying objects in a space.

### BACKGROUND

Objects are identified mainly by sensors, such as image sensors, IR sensors, radars, and the like. Objects may be persons, food items, furniture, vehicles, trees, leaves, buildings, and the like. The reasons to identify the objects may vary from surveillance, improving agriculture yields, performing medical procedures, navigation, fixing technical problems in the identified objects, and many more.

Standard techniques to identify objects include capturing images or another type of measurements, extracting the object from the image and comparing the object from the captured image to a bank of objects, and if the difference is small enough, deciding that the object in the image is identified as an object of a certain type, for example, a specific model of boots manufactured by Timberland. Then, with the birth of Machine learning and Artificial Intelligence, models are trained to identify the objects. Standard models (“AI/Neural Network”) identify objects using bounding boxes(corners) or full segmentation (detecting the entire object). However, this process requires long training processes, and sometimes different models for different objects, or large amounts of computation resources that are commonly used by online computation platforms such as Azure, AWS, and others, while there is a need to identify the objects in the mobile electronic device that moves in the space.

### SUMMARY

The invention, in embodiments thereof, discloses a method for identifying objects by a mobile robot moving in a space, the method comprises obtaining a map of the space, said map comprises objects and objects' locations in the space, moving the robot inside the space, localizing the moving robot in the space, capturing an image in the space using an image sensor of the mobile robot, identifying an object from the captured image, computing a relative direction of the object from the camera's direction at the time of capturing the image, determining that the object that appears in the image is the same object that appears on the map based on the relative direction, the robot's location when capturing the image and the object's location on the map.

In some cases, the method further comprises computing an appearance probability that represents a probability that the object that appears in the captured image also appears on the map.

In some cases, the map includes multiple sub-maps, the multiple sub-maps include objects located in sections of the space. In some cases, the map may comprise geolocation coordinates of the objects' locations.

In some cases, the localizing comprises computing a distance and an azimuth relative to a reference point representing a location of another object whose location is known. In some cases, the method further comprising assigning an orientation value that represents the azimuth and angle in a vertical plane of the camera when capturing the image. In some cases, computing a relative direction of the object from the camera's direction comprises converting objects' coordinates to angles in the camera's referential.

In some cases, determining that the specific object is the same object that appears on the map comprises determining that the range angle is lower than a threshold angle. In some cases, the threshold angle differs among the objects in the space. In some cases, the threshold angle is updated by an operator of the mobile robot. In some cases, the threshold angle is automatically updated based on environmental measurements.

In some cases, the method further comprises identifying the object from the captured image as the object appearing on the map in case the difference between the relative direction extracted from the image and the estimated direction extracted from the map is smaller than the angle threshold. In some cases, the object is selected from a door or a window, wherein the method further comprises detecting a position of the door or the window, wherein the position is selected from a group consisting of fully open, partially closed or entirely closed.

In some cases, the method further comprises computing a location probability indicating a probability that the mobile robot is located in a specific area in the space, wherein determining that the specific object is the same object that appears on the map comprises determining that the range angle is lower than a threshold angle, computing an appearance probability that represents a probability that the object that appears in the captured image also appears on the map, determining that the object captured in the image is the object on the map by multiplying the appearance probability by the location probability of the areas in the space in which the angle between the camera's direction and the relative location in the map satisfied the threshold angle.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

### In the Drawings:

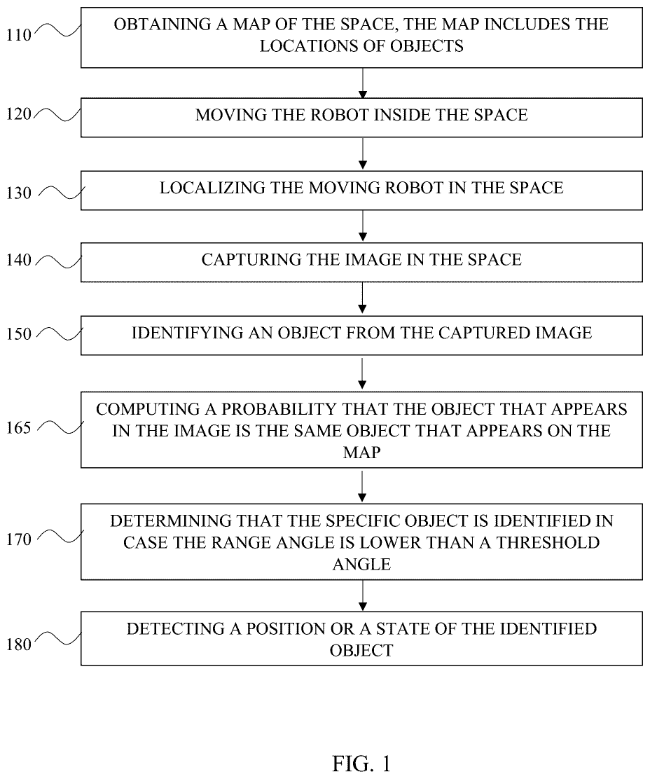

FIG. 1 shows a method for identifying objects by a mobile robot moving in a space, in accordance with some embodiments of the invention,

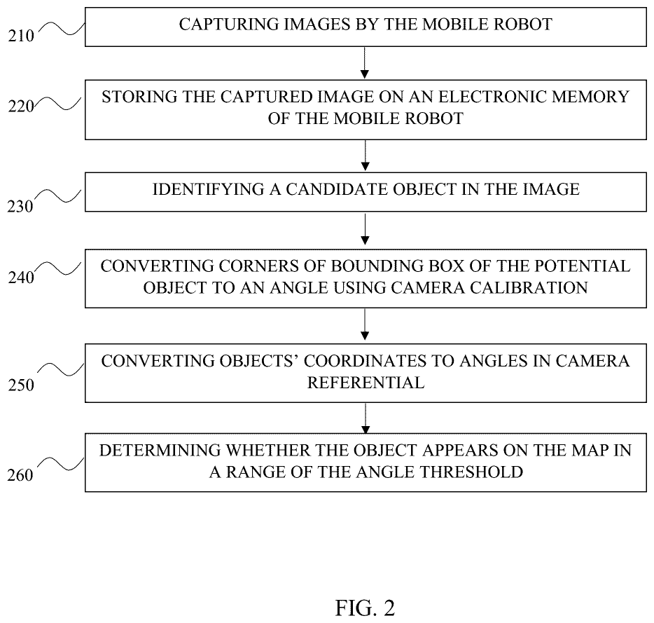

FIG. 2 discloses a method for processing images captured by the mobile robot in order to identify objects in the space, according to exemplary embodiments of the invention,

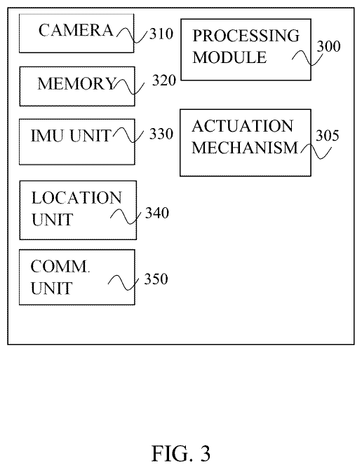

FIG. 3 shows a mobile robot capable of identifying objects in a space, in accordance with some embodiments of the invention,

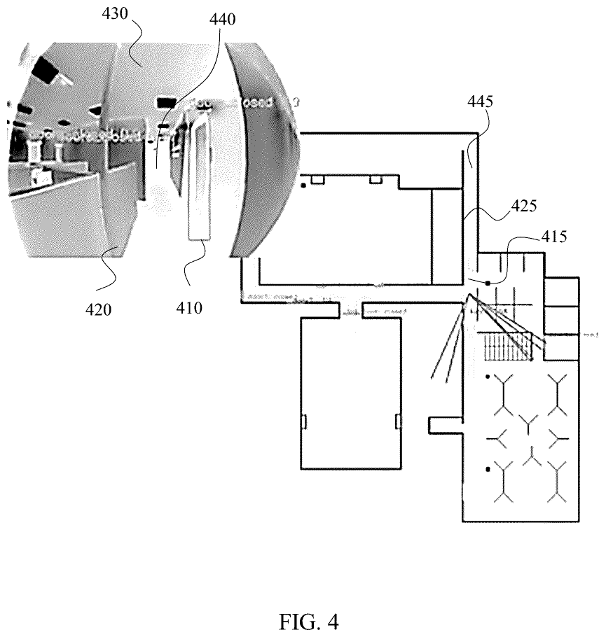

FIG. 4 shows an image captured by the mobile robot and a map that shows objects appearing in the image, according to exemplary embodiments of the invention.

### DETAILED DESCRIPTION

The invention, in some embodiments thereof, relates to methods for identifying objects in a space. The space may be an indoor space, inside a building, a warehouse or a house, or outdoors. The space may be outdoors, such as a garden, a court, a yard, field, and the like. The objects in the space also appear on a digital map, for example using world-based coordinates or pixels on a map. The objects appear on the map in a manner that enables the mobile robot to estimate a location of the objects relative to the mobile robot. Then, based on the location of the objects on the map and the captured image, the mobile robot can determine whether or not this is the object on the map.

The method further comprises identifying a position or a state of the identified object. The position may be defined as whether a door is open, closed, or partially closed. The position may define a person standing, seating, or lying on a floor.

FIG. 1 shows a method for identifying objects by a mobile robot moving in a space, in accordance with some embodiments of the invention.

At 110, the method discloses obtaining a map of the space, the map includes the locations of objects. The map may include sub-maps, the sub-maps include objects located in sections of the space, such as different rooms, halls, or warehouses on a given floor, or a different submap for different floors in a building. The map may be in a format of an image. The map may comprise geolocation coordinates. The map may comprise a reference point (coordinates 0,0) in a known point in the space, for example, a specific corner in a room or in a building. The objects in the map may be represented according to their distance from another object, for example from the reference point. The distances may consider the size (for example, width and height) of the objects. For example, object #1 may be located at 6.2-7.8 on the X-axis and 0.15-0.4 on the Y-axis, meaning that object #1 has a width of 160 centimeters and a height of 25 centimeters. In some other cases, the objects may be represented according to their world coordinates. In some other cases, the objects may be represented in an estimated manner, such as “door #12 is located in the entrance to room #4, 4.5 meters along corridor #1”.

The map may be stored in the memory of the mobile robot or in a memory of a remote device, such as a server or a web-based service, such as Amazon Web Services (AWS), Google Cloud, and the like.

At 120, the method discloses moving the robot inside the space. The movement may be of a predefined path, for example from point A to point B, or based on a command having a destination “move to the last window”. The movement may be performed periodically, for example, once every 15 minutes on the same path, or based on an event, such as the detection of light, noise, gas, presence of a suspicious object, and the like. The movement may begin from a docking station used to provide electronic power to the mobile robot.

At 130, the method discloses localizing the moving robot in the space. Localizing the mobile robot is defined as estimating the mobile robot's location in the space. The location may be defined as world coordinates, a distance and azimuth relative to the reference point, a distance and azimuth relative to another object whose location is known, and the like. Localizing the mobile robot may be done using a sensor, such as the robot's motion sensors, the robot's inertial measurement unit (IMU), image sensors, radars, and other mechanical or electronic components that generate signals, such as radiation signals, Radio Frequency signals, illumination (also in the non-seen wavelength) and other signals. The signals are then collected by a signal receiver of the mobile robot and analyzed based on a set of instructions stored in the mobile robot's memory in order to localize the mobile robot. The memory may also store prior locations of the mobile robot and time stamps of the prior locations and use the prior locations as well as data collected from the motion sensors and the IMU to localize the mobile robot. The mobile robot may be localized by identifying an object, such as a sticker placed at the space's ceiling, and computing a distance and a relative direction from the sticker.

At 140, the method discloses capturing the image in the space. The image may be in a grayscale format, RGB format, or any other format desired by a person skilled in the art. The image may be captured by an image sensor of the mobile robot. The mobile robot may assign an orientation value that represents the azimuth and angle in the vertical plane (from top to bottom) of the camera when capturing the image and a time stamp for the captured images. The azimuth of the camera may differ from a movement direction of the mobile robot.

At 150, the method discloses identifying an object from the captured image. Identifying may be done using a set of instructions, or using a software-based model, such as a machine learning model that receives the captured image as input. The output of the model may be a value representing a probability that the potential object is indeed the object. For example, a probability of 0.85 that the suspicious object in the top-left corner of the image is a table.

In some exemplary embodiments, identifying the object from the captured image comprises computing or estimating the object's location using depth estimation methods, using a depth estimation desired by a person skilled in the art. The depth estimation can provide the range and heading of the object from the robot's camera and by adding the robot's pose, the output may include the object's estimated position. This position can be compared to the object's location on the map to provide further information and validate the assessment that the specific location on the map is indeed identified on the captured image.

At 165, the method discloses computing a probability that the object that appears in the image is the same object that appears on the map. The probability may be computed based on a range angle. The range angle is computed according to a difference of two relative directions—1. The relative direction of the object as analyzed from the image. 2. The relative direction of the object as appearing on the map from the mobile robot's location in the time stamp of capturing the image, while considering the direction offset between the mobile robot's header and the camera's angle on the mobile robot. For example, the image processing algorithm may output that the object is located in the range of 10-12 degrees to the right from the camera's header, while a mapping process outputs that the object is located 22 degrees to the right from the camera's header. This way, the range angle is 10 degrees. A function that outputs the probability receives as input the range angle and a set of instructions.

At 170, the method discloses determining that the specific object is identified in case the range angle is lower than a threshold angle. For example, the threshold angle may be 25 degrees in the horizontal plane. The threshold angle may differ from one object to another. The threshold angle may be updated or configured by an operator of the mobile robot. The threshold angle may be automatically updated based on environmental measurements, such as the amount of light in the space, collected measurements by other sensors in the space and the like. In case the difference between the relative direction extracted from the image and the estimated direction extracted from the map is smaller than the angle threshold, the specific object of the map is identified as appearing on the captured image.

At 180, the method discloses detecting a position or a state of the identified object. The object may be a movable object, such as a door, a window, or another object predicted to be present in the space. The position may be defined by whether a window or a door is fully open, partially closed or entirely closed. The position or state may be selected form a closed group of optional positions, or may be represented as a value outputted by the mobile robot, such as “38% of the door is open”. The mobile robot may then generate a message to a remote device or account, such as an email account, a cellular phone, a server and the like. In some cases, the message may be generated only in case the detected position is different from a desired position for the specific object, as the desired position is also stored in the mobile robot's memory.

In some cases, the method comprises computing an appearance probability indicating the probability that the target object spears in the image. The probability may be provided by a software model that receives the captured image as input. The model may receive an identifier of the target object, for example, “1” for a door, “2” for a window, and “3” for a table.

In some cases, the method comprises computing location probability indicating a probability that the mobile robot is located in a specific location. The location probability may refer to a range of areas in the space, such as 10*10 centimeters in the X and Y axes. The location probability may be computed for an array of areas in the space, such as a probability of 0.1 for location #1, a probability of 0.18 for location #2, a probability of 0 for location #3, a probability of 0.43 for location #4, and the like. This way, in order to determine that the object captured in the image is indeed the object on the map, the appearance probability is multiplied by the location probability of the areas in the space in which the angle between the camera's direction and the relative location in the map satisfied the threshold angle. For example, there may be eight (8) locations that received a location probability higher than 0, of which only 5 locations satisfy the threshold angle condition, and the sum of the probability locations of these 5 locations is 0.72. if the appearance probability is 0.75, the probability that the object in the image is the object on the map is 0.54.

FIG. 2 discloses a method for processing images captured by the mobile robot in order to identify objects in the space, according to exemplary embodiments of the invention.

At 210, the method discloses capturing images by the mobile robot. The image may be of grayscale format, RGB format, or any other format desired by a person skilled in the art. The image may be captured by an image sensor of the mobile robot.

At 220, the method discloses storing the captured image on an electronic memory of the mobile robot.

At 230, the method discloses identifying a candidate object in the image. The candidate object may be selected from a closed group of objects, such as trees, doors, windows, persons and the like. Features of the candidate objects may be stored in a memory of the device that analyzes the captured images.

At 240, the method discloses converting corners of bounding box of the potential object to an angle using camera calibration. For example, in case the object has a predefined standard shape, deviations from the standard shape are mapped to angles from the camera. For example, a door known as appearing in the space is represented at a pixel ratio of 1:3 when located in front of the camera, a pixel ratio of 1:4 when located at a range of 15-30 degrees right or left from the camera, a pixel ratio of 1:6 when located at a range of 30-45 degrees right or left from the camera and the like.

At 250, the method discloses converting objects' coordinates to angles in camera referential. This process may be performed by convert the pixels identified as representing the identified object with the known camera calibration parameters, which are intrinsic parameters known to the system that executes the process. Then, the process comprises calculating the calibrated pixel angle with respect to the camera axis.

At 260, the method discloses determining whether the object appears on the map in a range of the angle threshold. The angle threshold may be 0.5 in the radial domain.

FIG. 3 shows a mobile robot capable of performing the method of identifying objects in a space, in accordance with some embodiments of the invention.

The mobile robot comprises a processing module 300 configured to process the aerial device's missions, and other actions performed by the mobile robot. Thus, the processing module 300 is coupled to the actuation mechanism 305 configured to move the mobile robot. Such coupling may be via an electrical channel or cable, wireless communication, magnetic-based communication, optical fibers and the like. The processing module 300 may send a command to the actuation mechanism 305 to move to a certain location in order to perform a mission, such as monitoring, cleaning, moving goods from one place to another, and the like. The command may include instructions as to how to move to the certain location. The processing module 300 as defined herein may be a processor, controller, microcontroller and the like.

The mobile robot may comprise an actuation mechanism 305 for moving the mobile robot from one place to another. The actuation mechanism 305 may comprise a motor, an actuator and any mechanism configured to maneuver a physical member desired by a person skilled in the art. The actuation mechanism 305 may comprise a rotor of some sort, or another mechanism enabling the mobile robot to fly. The actuation mechanism 305 is coupled to a power source, such as a battery or a renewable energy member, such as a solar panel in case the area comprises or is adjacent to an outdoor area accessible to the mobile robot. The actuation mechanism 305 may move the mobile robot in two or three dimensions.

The mobile robot may comprise a camera unit 310 including one or more cameras for capturing images and/or videos. The cameras of the camera unit 310 may be mechanically coupled to arms or other tilting mechanisms for changing the position of one or more of the cameras relative to the heading of the mobile robot. The processing module 300 may control the properties of the images captured by the cameras, such as size, resolution, grayscale or RGB and the like.

The mobile robot comprises a memory 320 for storing data. The memory 320 comprises instructions to activate a wireless network in response to identifying a motion identified by sensors of the mobile robot. The memory 320 may also store a unique name to be used as a name of the wireless network activated by the mobile robot in response to identifying the configuration gesture. The memory 320 may also store a code or password to be inputted by a user of a remote device when requesting access to the wireless network activated by the mobile robot.

The robot device comprises an inertial measurement unit (IMU) 330 configured to measure the electronic device's linear acceleration and angular velocities. The measurements collected by the IMU 330 may be transmitted to the processing module 300 configured to process the measurements. The IMU 330 may comprise one or more sensors, such as an accelerator, a gyroscope, a compass or magnetometer, a barometer and any the like.

The robot device may also comprise a Location unit 340 configured to locate the mobile robot's location. The location unit 340 may include a GPS receiver, wireless receiver that enable triangulation technique to locate the mobile robot, other sensors used to locate the mobile robot and additional techniques desired by a person skilled in the art.

The robot device also comprises a wireless communication unit 350 via which the remote device communicates with the mobile robot. The wireless communication module 350 is configured to receive wireless signals, such as data transmitted over RF, Bluetooth, Wi-Fi channels. The wireless communication network 350 may comprise an antenna for receiving and sending signals. In some cases, wireless communication network 350 may be deactivated in an initial state, and activated only after identifying the configuration gesture applied on the mobile device.

FIG. 4 shows an image captured by the mobile robot and a map that shows objects appearing in the image, according to exemplary embodiments of the invention. The image may be of a rectangular shape, having 4 bounding corners. The image may be of grayscale format, RGB format, or any other format desired by a person skilled in the art. The image shows a door 410, a cubical wall 420, a ceiling 430, and a corridor 440 defined between walls and some furniture. The map shows the respective locations of the objects that appear in the captured image. For example, the location 415 of the door 410, the location 415 of the cubical wall 420, the location 435 of the ceiling 430, and the location 445 of the corridor 440.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the invention. To the extent that section headings are used, they should not be construed as necessarily limiting. In addition, any priority document(s) of this application is/are hereby incorporated herein by reference in its/their entirety.

What is claimed is:

1. A method for identifying objects by a mobile robot moving in a space, the method comprising:
obtaining a map of the space, said map comprises objects and objects' locations in the space;
moving the robot inside the space;
localizing the moving robot in the space;
capturing an image in the space using an image sensor of the mobile robot;
identifying an object from the captured image;
computing a relative direction of the object from the camera's direction at the time of capturing the image; and
determining that the object that appears in the image is the same object that appears on the map based on the relative direction, the robot's location when capturing the image and the object's location on the map.

2. The method of claim 1, further comprising computing an appearance probability that represents a probability that the object that appears in the captured image also appears on the map.

3. The method of claim 1, wherein the map includes multiple sub-maps, the multiple sub-maps include objects located in sections of the space.

4. The method of claim 1, wherein the map may comprise geolocation coordinates of the objects' locations.

5. The method of claim 1, wherein the localizing comprises computing a distance and an azimuth relative to a reference point representing a location of another object whose location is known.

6. The method of claim 1, further comprising assigning an orientation value that represents the azimuth and angle in a vertical plane of the camera when capturing the image.

7. The method of claim 1, wherein computing a relative direction of the object from the camera's direction comprises converting objects' coordinates to angles in the camera's referential.

8. The method of claim 1, wherein determining that the specific object is the same object that appears on the map comprises determining that the range angle is lower than a threshold angle.

9. The method of claim 8, wherein the threshold angle differs among the objects in the space.

10. The method of claim 9, wherein the threshold angle is updated by an operator of the mobile robot.

11. The method of claim 9, wherein the threshold angle is automatically updated based on environmental measurements.

12. The method of claim 9, further comprising identifying the object from the captured image as the object appearing on the map in case the difference between the relative direction extracted from the image and the estimated direction extracted from the map is smaller than the angle threshold.

13. The method of claim 1, wherein the object is selected from a door or a window, wherein the method further comprises detecting a position of the door or the window, wherein the position is selected from a group consisting of fully open, partially closed or entirely closed.

14. The method of claim 1, further comprising:
computing a location probability indicating a probability that the mobile robot is located in a specific area in the space, wherein determining that the specific object is the same object that appears on the map comprises determining that the range angle is lower than a threshold angle;
computing an appearance probability that represents a probability that the object that appears in the captured image also appears on the map; and
determining that the object captured in the image is the object on the map by multiplying the appearance probability by the location probability of the areas in the space in which the angle between the camera's direction and the relative location in the map satisfied the threshold angle.
